(19) United States
(12) Patent Application Publication
(10) Pub. No.: US 2013/0151420 A1
(43) Pub. Date: Jun. 13, 2013

(54) ONLINE BUILDING

(71) Applicants: Rami Teshuva, Netanya (IL); Benny Shani, Ramat Hasharon (IL)

(72) Inventors: Rami Teshuva, Netanya (IL); Benny Shani, Ramat Hasharon (IL)

(21) Appl. No.: 13/313,044

(22) Filed: Dec. 7, 2011

(51) Int. Cl. G06Q 10/06

(52) U.S. Cl. 705/301

(57) ABSTRACT

A computer program product for managing projects online, including managing an Approved Project Plan having an Overview plan and Detailed plans which may be viewed and modified or only viewed, depending on clearance type.

### FIELD AND BACKGROUND OF THE INVENTION

The present invention relates to an online system for managing building projects and, more particularly, to a system for facilitating improved management and implementation of building projects with an online interface.

Building projects are notorious for delays, mistakes and improper management. Often, a building project is incorrectly implemented and then has to be redone (often demolished and rebuilt) leading to delays, wastage and overall aggravation. The large number of diverse craftsmen involved in a single building project plays a large roll in the various mishaps that visit every building site. Even teams that regularly work together on various building projects, such as a building contractor that uses the same plumber for the piping, electrician for the wiring, tile layer for the flooring, roofer for the roof and architect for the plans, are prone to making time and money consuming mistakes.

One factor that lies at the base of many of the problems is a lack of efficient and clear communication between the parties. The chasm that lies between the digital drawing plans created on the latest architectural software which is printed by the highest quality specialty laser printers in the architect's office and the mason mixing the cement and laying the bricks according to the latest pencil marked plans at the building site, is vast indeed. It is common, for example, for a builder to be using one version of plans while the owner has been sitting with the architect and making small- to wide-ranging changes to the plans. The contractor for this project may arrive at the building site to find that the newly built bathroom has to be moved two meters to the right to facilitate a wash basin.

Various software packages for project management exist. All of these packages provide management tools for essentially homogenous teams. The term homogenous here refers to the fact that these teams are either physically located in the same work space (which allows for face-to-face discussions, clarifications and updates) or virtually using the same work space and/or shared resources. Even widely dispersed members of a team generally share common membership in a group or are employed by a central entity. In these cases, direct modes of communication exist between all members, or at least all members have direct communication with the centralizing entity and can receive information, updates, clarifications etc. via established communication routes. For example, a trucking company that hauls good all over the United States can be in fluid contact with any or all of the truckers over their radios or company cell phones. At the very least a centralizing switchboard or secretary has all the necessary contact information, as this information is gathered during the course of employment or enrollment in the group.

The situation in building projects is very different. Often an owner selects an architect and contractor to do a project. These individuals may not know each other or may not have worked together previously. The contractor often brings in various tradesmen during the course of the project. The owner may have no say in the selection of these professionals and may not even approve of the selection. Conversely, if the owner selects the tradesmen instead of the contractor, the selected group may not have a working relationship or familiarity among the members. This kind of organization (or lack thereof) is bound to lead to confusion, miscommunication and mistakes—as we see every day in almost every building site.

Another common misstep is confusion between projects going on simultaneously. A good contractor usually has a few building projects going on at the same time with various teams working at each of the sites. It is not uncommon for a contractor to bring a team to worksite A, only to find that the plans he has brought belong to worksite B. Team A then spends the next 2 hours doing nothing while the contractor either goes back to the office, or worse, to worksite B, and then returns with the correct (and hopefully up-to-date) plans. Delays and mistakes such as the aforementioned (and many others) are likely to be responsible for hundreds of millions, if not billions, of dollars being wasted every year in building sites the world over.

It would be highly advantageous to have a centralizing system that provides the most up-to-date information regarding a particular building project, online, where each member of the team can access the information that is relevant to the assignment tasked to perform, and where a change that is made at an administrative level is disseminated down to each tradesman and worker according to the ramifications that the change effects on a given task.

### SUMMARY OF THE INVENTION

According to the present invention there is provided a computer program product for managing projects including (a) a computer useable medium having computer readable instructions embodied therein for managing an Approved project Plan wherein the computer readable instructions, when executed on a computer, cause the computer to: (i) receive an Overview plan from a Design Manager; (ii) receive at least one Detailed Plan relating to at least a portion of the Overview plan, wherein the at least one Detailed plan is subject to approval by the Design Manager before the at least one detailed plan is included in the Approved Project Plan; (iii) grant view-and- modify access to at least a portion of the Approved Project Plan to a user having a modification clearance, wherein the view-and-modify access allows the user to suggest a modification to the Approved Project Plan; and (iv) grant view-only access to at least a portion of the Approved Project Plan to a user having a view-only clearance, wherein the view-only access allows the user with view-only clearance to only view the Approved Project Plan and disallows the user from suggesting a modification to the Approved Project Plan.

According to further features in preferred embodiments of the invention the computer readable instructions, when executed on a computer, further cause the computer to: (v) alert the Design Manager regarding a suggested modification to at least one Detailed plan of the Approved Project Plan; (vi) modify the at least one Detailed plan of the Approved Project Plan according to the suggested modification if the suggested modification is approved by the Design Manager; and (vii) alert users with view-only and modification clearance for the modified Detailed plan of the Approved Project Plan, regarding the modification.

According to still further features in the described preferred embodiments the alerting is accomplished by a method selected from the group including: automatically alerting, semi-automatically alerting and manually alerting.

According to still further features the alerting of the users includes sending a data-stream to the users in a form selected from the group including: a Short Text Service (SMS) message, an electronic mail (e-mail) message and an information message viewable via a Graphical User Interface (GUI) of the computer program product.

According to still further features the project management package further includes: (b) a Database (DB) including a Directory of Professionals (DOP), wherein the DOP includes information regarding Project Professionals; and (c) a Request for Proposal (RFP) module, for sending an RFP to at least one the Project Professional, selected from the DOP.

According to still further features the project management package further includes: (d) a Rating module, for rating the Project Professionals, the rating being stored in the DB.

According to still further features the granting of view-and-modify access and view-only access is effected by the Design Manager.

According to still further features the Approved Project Plan is accessible, according to clearance, online over a data network.

According to still further features the Overview Plan includes Architectural Drawings.

U.S. patent application Ser. No. 12/690,026 to Scholar discloses an interactive and collaborative, planning, designing and facilitating tool that connects users with organized information and relevant data, providers and facilitators to resolve technical issues in conceptualizing, designing and implementing a custom project. One of the problems that the Scholar disclosure solves is providing a complete and detailed document including all the data relating to a project, from conception to implementation. To this end, data input from those tradesmen implementing the plan is indispensible. Conversely, the current innovative system is intended, primarily, to serve the tradesmen implementing the plan, but disallows any input from those individuals on the implementation level. The Implementers are granted view-only access to the most up-to-date approved plans, each according to his or her own field and/or project assignment.

### BRIEF DESCRIPTION OF THE DRAWINGS

Various embodiments are herein described, by way of example only, with reference to the accompanying drawings, wherein:

FIG. 1 is a schematic diagram of an exemplary computing system for implementing the embodiments of the present innovation;

FIG. 2 is a clearance access-hierarchy pyramid of an embodiment of the current innovation;

FIG. 3 is an exemplary implementation of a management hierarchy;

FIG. 4 is an information flow diagram of an embodiment of the innovation;

FIG. 5 is an exemplary flow diagram for a building project;

FIG. 6 is a schematic block diagram of a server according to one embodiment of the invention.

### DESCRIPTION OF THE PREFERRED EMBODIMENTS

The principles and operation of a Project Management System according to the present invention may be better understood with reference to the drawings and the accompanying description.

Computing System

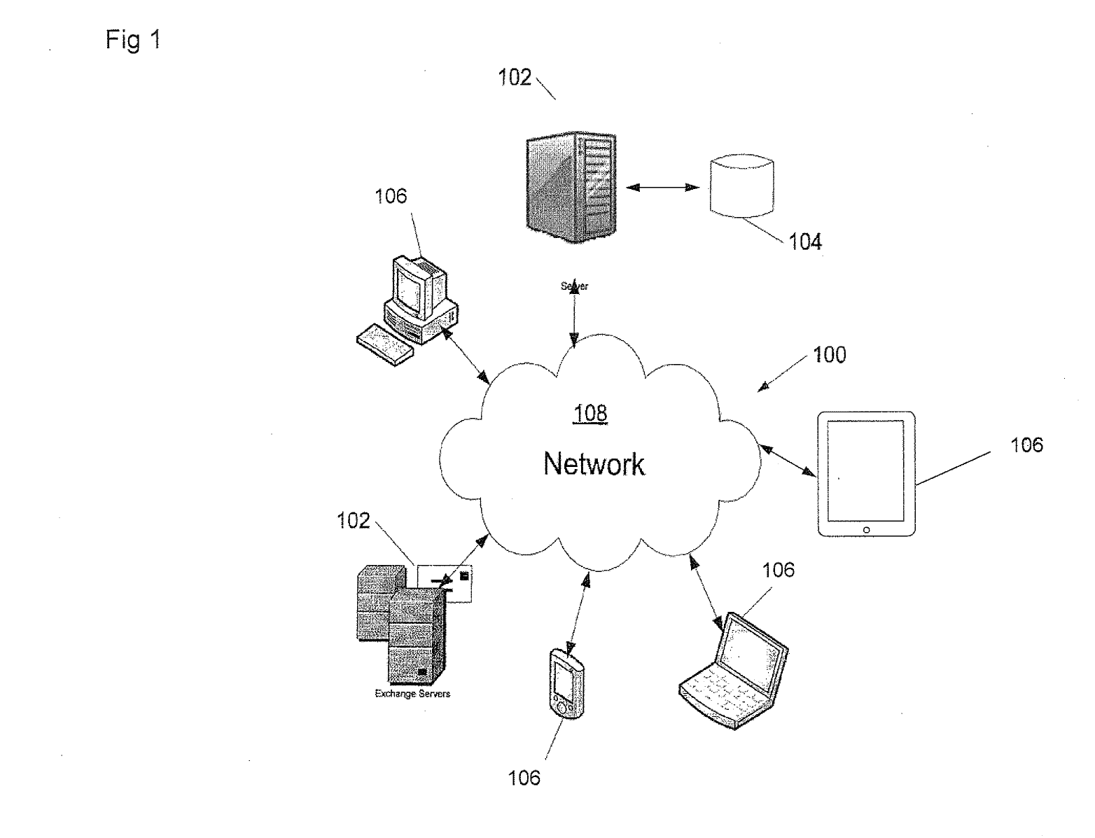

Referring now to the drawings, FIG. 1 is a schematic block diagram illustrating one embodiment of a computing system 100 for executing the adaptive technical features of the present disclosure described below in detail. In one exemplary embodiment, the computing system 100 may include a server 102 or network of exchange servers 102 in communication with a database 104, and one or more server clients, workstations, mobile devices (smartphones, iPads™ etc.), laptops 108 connected to the server 102 through a data network 108. The data network 106 includes a Local Area Network (LAN), or alternatively, may include a wireless LAN, a Wide Area Network (WAN), the Internet, a Virtual Private Network (VPN) and the like. In one embodiment, the server 102 may include a software application that remains on the server 102 where the clients use a web browser to interact with the software application.

The server 102 may provide application services, web services, mail services, data storage services, and communication services, used to support operations of the adaptive embodiments. The server 102 may host an apparatus, software application, or the like to perform the operations of the disclosed embodiments. In one embodiment, a single server 102 may provide some or all of theses services, or a plurality of servers 102 may be used to provide these services. The database 104 stores data for use by the server 102. The database 104 may be remote to the server 102, or may reside on the server 102. The database 104 may include a storage controller, data storage devices such as magnetic, solid state, or optical storage disks, data input/output (I/O) controls, and the like as are well known in the art.

Network

In one embodiment, the project management system may be provided in the form of a computer program product for managing projects. The computer program product may include a computer useable medium having a computer readable program, where the computer readable program when executed on a computer causes the computer to perform various steps. The computer useable medium may be the hard disk of a computer (such as server 102). Alternatively and/or additionally the computer useable medium may be a flash disk or a CD/DVD and the like, as is well known in the art.

In another embodiment, network interface circuitry is provided and configured to receive data and transmit data over a network. At least one data processor is coupled to the network interface circuitry and configured by program instructions to generate a Segmented Project Plan based on data received into the planning system The data processor may also command transmissions of at least a part of the Segmented Project Plan over the network.

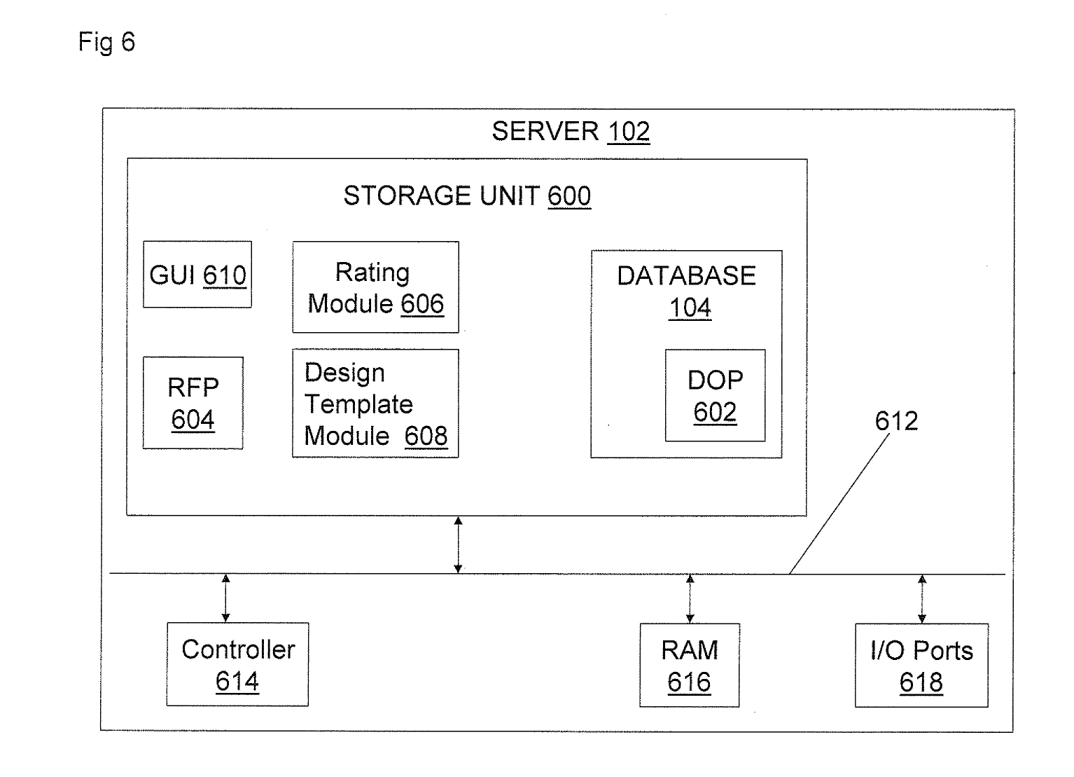

Database of Professionals/Project Tender FIG. 6 is a schematic block diagram of server 102 with an internal database 104. In some preferred embodiments, Server 102 includes at least a controller, microcontroller or CPU 614 for performing executive functions of the server. Software modules include instructions that are loaded into a RAM 616 and excecuted by controller 614. Data enters into the server and is sent from the server to external source via I/O ports 618. The storage unit 600, controller 614, RAM 616 and 1/0 ports 618 are connected by a bus 612. Database 104 resides in storage unit 600. Storage unit 600 further includes at least software modules detailed hereafter. Software module for GUI 610 is also included in the Storage unit 600. Database 104 may include a Directory of Professionals (DOP) 602. The project management system may be configured to support various types of projects that require heterogeneous groups and individuals to work together on a common project. In one preferred embodiment of the system, database 104 includes a directory of professionals 602 categorized according to project type (Project Professionals). For example, a building project directory may include professionals such as Architects, Engineers, Designers, Builders, Installers and the like. It is clear that many professionals may belong to more than one project type. The system includes program modules which include instructions embedded on a computer-readable medium which, when implemented on a computer, may cause the computer to do various activities. The system may include a Tender Program Module or RFP (Request for Proposal) module 604 which provides a user with a tool for selecting/compiling a Project Team. Part of the selection process may include sending tender offers for various positions on the team. A Rating Module (RM) 606 assists users to selected professionals according to objective or subjective ratings.

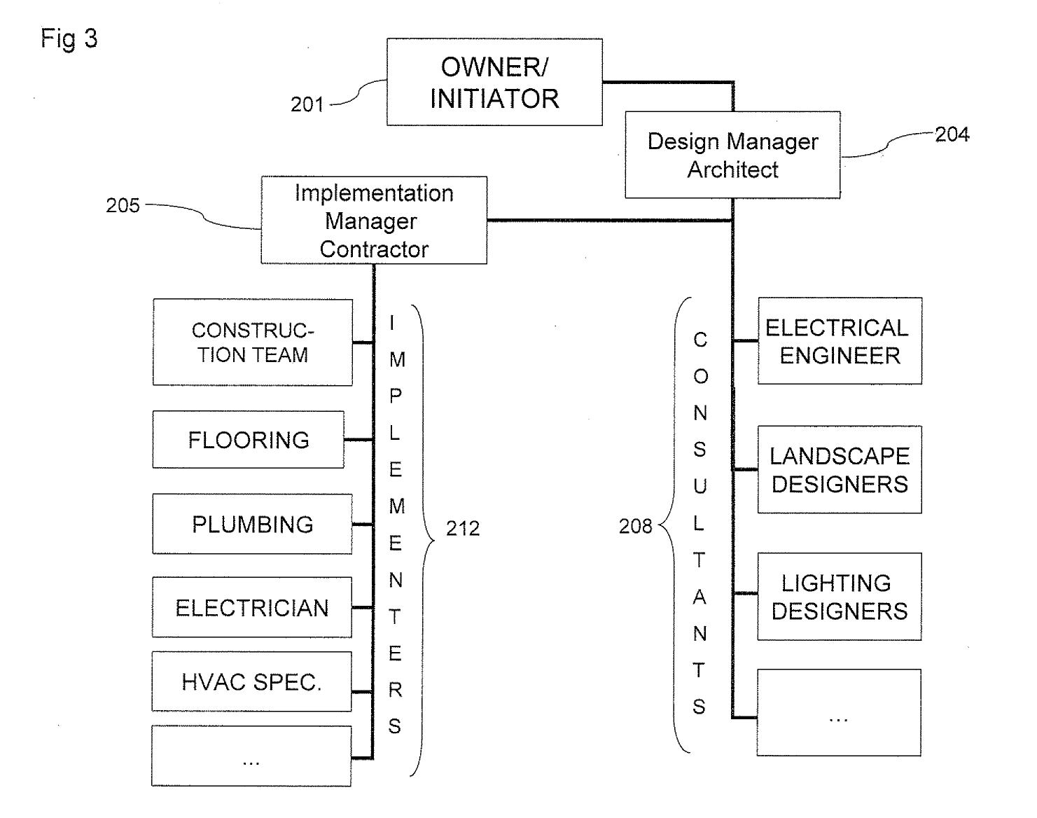

FIG. 3 depicts an exemplary hierarchy of the Project Management System. Following the building project example (this example will be followed throughout the disclosure), an Owner/Initiator 302, who would like to plan and implement a project selects a project type and is then presented with a list of professionals who can be selected to manage the building project. For example, an owner may select a Building Contractor or an Architect to manage the entire building project. Of course, the owner may designate himself as the Design Manager, where applicable. In some embodiments, there is a Design Manager 204 and an Implementation Manager 205. Design Manager (DM) 204 is in charge of all aspects of the project that relate to the designs, drawings and plans of the project Implementation Manager (IM) 205 is in charge of the aspects of the project that relate to the practical implementation of the project according to the project designs/plans. An Architect or Civil Engineer may be chosen/selected as the DM whereas a Building Contractor or Controller may be selected as the IM. In an example where the owner selects an Architect as the desired profession from which to choose a DM, a list or sub-directory of Architects may be displayed to the owner (via a GUI on a web-browser or client program downloaded from a system server [such as Server 102] and remotely connected to the database). Potentially, biographical and/or professional data (such as qualifications, experience, client and/or colleague recommendations, etc.) relating to the Architect may be accessible to the owner for perusal. The owner may immediately select one Architect from the list or alternatively, the owner may select two or more Architects and send (via the system) a request for proposal (RFP) for the building project to the selected Architects. The Architects may view the proposals on the innovative system and present their bid, according to the parameters set by the owner. Parameters may include a time limit for the bid to be submitted, a request for a time frame for project completion, pricing (of course) etc. Once the bids are in, the owner can make the selection of who will be the Design Manager 204.

Once the tender has been awarded to a DM, the Owner/Initiator 201 awards the DM 204 access and limited control over the Project. In one preferred embodiment the DM 204 is an Architect. The Architect is given overall management and control over the Project, except for the right to cancel the Project. The right of cancellation belongs to the Owner/Initiator. The Owner/Initiator may be an individual or group either partially or completely owning the rights to the project, or an elected, selected or otherwise chosen individual/group charged with responsibility for the Project. In some embodiments, the Project, Management System includes a Design Template Module (DTM) 608 (FIG. 6) for creating a Design Template for the project according to type and sub-type. In the system, the DM 204 selects a project sub-type which further clarifies the type of project in question. In a non-limiting example, the project type is a ‘Building Project’ which was selected previously (or at this time, if the project creation is beginning at this point and an Architect has already been selected) and the sub-type is selected as a ‘Private Home’. The DM/owner 204 is guided through a sequence of GUI screens on the system which provide a step by step guide to creating the template for a project of type: Building; and sub-type: Private Home. For example, the number of floors is selected; a checkbox list of features and structures (lobby, roof, first floor bathroom etc.) is provided and checked off; types of mini-projects included in the general project, such as Interior Design, Landscaping etc., are selected and so on. The system then generates a Design Template according to which Architectural Drawings and/or Detailed Plans must be prepared.

Further tender offers may be made according to categories and tasks. The DM may send RFPs to various professionals, termed herein as Consultants 208, who, once selected, will be tasked with preparing detailed plans for the project. The DM may send Architectural Drawings and relevant sections of the Design Template with the RFP, where the relevant sections of the Design Template relate to the specific type of professionals who are the subject of the tender. Preferably, this is the manner in which the Design Team is assembled. Also preferably, the Consultants only deal with the design aspects of the project, not the implementation.

Concurrently or after the selection of the Design Team, an Implementation team must be assembled. An Implementation Manager (IM) 205 must first be selected. For example, the owner or DM 204 may select a Building Contractor or a Building Project Controller as the IM. This selection may be done via a direct choice, i.e. selecting a single Building Contractor from the Building Contractor sub-directory, or via tender, as described above. The same process can then be repeated (by the owner, DM or preferably the IM) for each of the Implementation Team members 212. It is clear that this process may not necessarily be applied to each individual team member, but rather to entire sub- groups/teams. For example, the Building Contractor is generally expected to have a construction team, but the electrician or plumber may be selected. A partial exemplary representation of a detailed hierarchy is shown in FIG. 3. In the exemplary representation, an Electrical Engineer is selected by the DM. The Engineer is then responsible for all the design aspects of the project relating to Electrical Engineering. The Electrical Engineer draws up detailed electrical plans according to the Architectural Drawings. A Building Project Controller is selected by the DM or owner to be the IM. As exemplarily depicted in the Figure, the IM (a Building Contractor) 205 must find an Electrician 212 to do the wiring, an air- conditioning expert 212 to install the HVAC system, as well as any other specialists for specific sub-projects such as installation of a home entertainment center. Potentially, the selection of these practitioners may be contingent on the approval of the Owner 201 or even the DM 204. Responsibility for the implementation of the project according to the designs/plans rests with IM 205 who is in charge of the Implementers liaises with the DM and owner.

In order to improve productivity and efficiency, a Rating Module 606 (FIG. 6), may be included in the System whereby individuals or groups can be rated by fellow professionals based on acquaintance and past experience. For example, Building Contractor (BC) may rate five electricians he has worked with in the past, according the previous work experience. John Smith may be rated as number one, whereas Jack Slacker may be rated five (and the other three are rated between 2 and 4). Then, when selecting an electrician, the Rating Module 606 (or the system employing the Rating Module) may present a short list of five of the objectively highest rated electricians, as averaged by ratings from all of the professionals in the directory, or by all of the BCs in the directory. If none of these are selected or desired, a longer list can be viewed. Alternatively (or additionally) the Rating Module can be configured to present the list according to the preference of the selected BC (as this is the person that will have to work with the electrician in the end of the day, and people who work better together do better work as a team than those who do not get along), but the overall rating may potentially still be displayed for each electrician. The objective/overall rating helps to minimize nepotism and provide the owner/Design/Implementation Manager with an objective yard stick for measuring potential performance and making informed decisions.

Project Plan Creation and Management

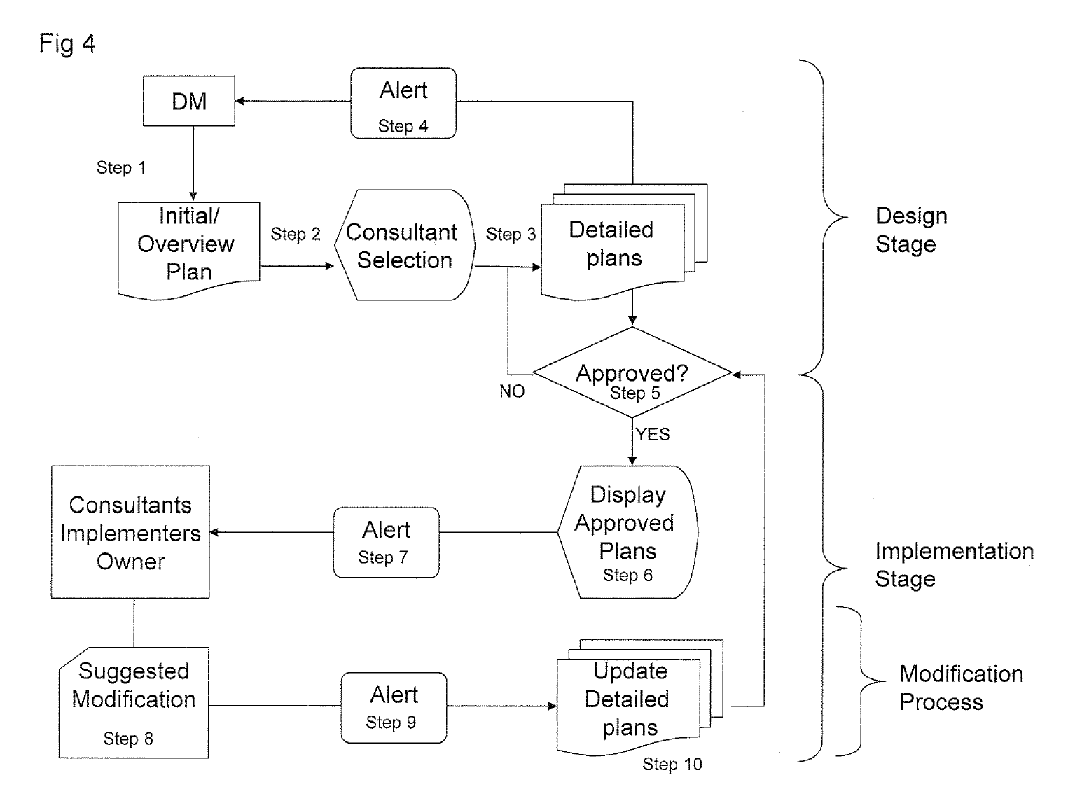

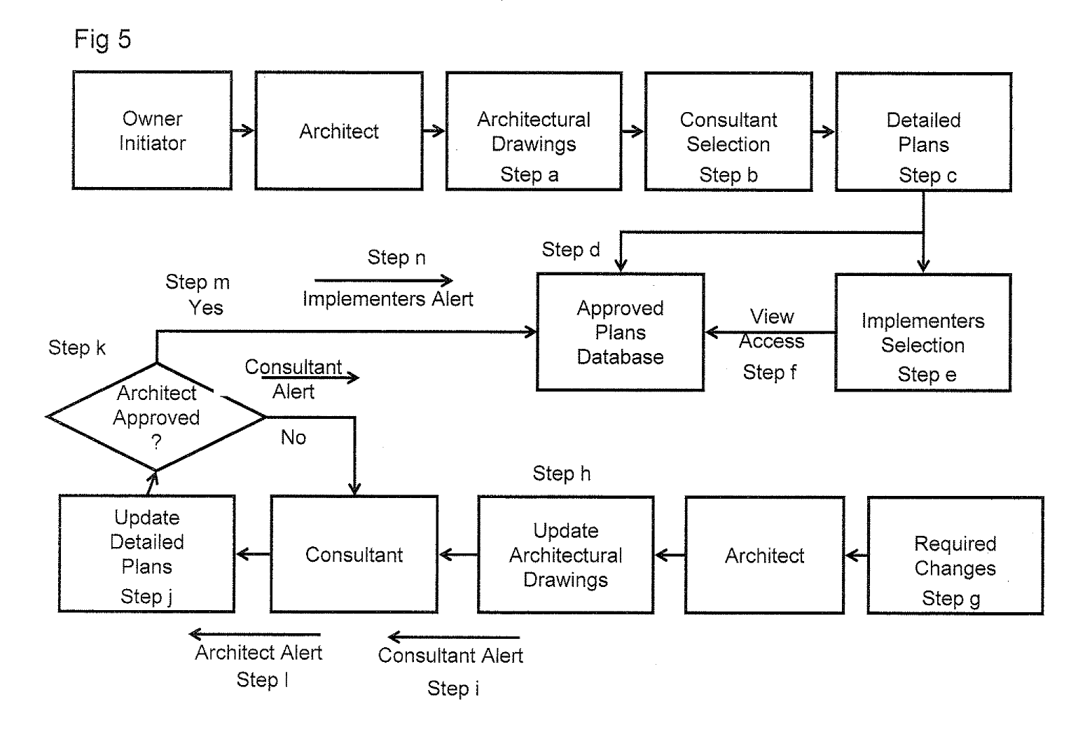

FIG. 4 depicts an Information Flow diagram of an embodiment of the innovative Project Management System. FIG. 5 depicts an exemplary Information Flow diagram for a building project. Reference is made to both Figures hereafter. In one embodiment, the Initial/Overview Project Plan is preferably a virtual (electronic) compilation of data, hosted on the system platform for viewing and outputting, that may be electronically deliverable, for example over Network 108, to other parties for viewing and potentially subsequent outputting as a printed document.

In the first stage of the process, the Design Stage, the DM enters an Initial/Overview Plan into the system (FIG. 5 step 1), including the general design of the project such as the architectural schematic plans (FIG. 6 step a) for the project (for example a building project). In step 2 (FIG. 5), Consultants are selected (FIG. 6 step b) from the Database of Professionals or from some other source. The selection of the Consultants may be made via tender as described above, or through direct selection. In step 3 (FIG. 5), each Consultant is tasked with preparing detailed plans (FIG. 6 step c) for the project (e.g. electrical system, plumbing, building shell, building interior, land surveying, etc.). The consultants are given a username and password which gives access to the given Project which is identified by a unique ID (usually relating to the address of the project, or the project owner or some combination of the two, but any unique ID would suffice). Furthermore, the Consultant is granted clearance to initially draw up and thereafter modify plans of the relevant Project Segments. Project Segments include the most up-to-date detailed plans, usually prepared by Consultants. All plans are subject to approval by the DM before becoming part of the Approved Project Plan (most up-to-date Architectural Drawings and Detailed plans). In step 4 (FIG. 5), the DM is alerted by the system that detailed plans have been submitted for approval. If the DM does not approve detailed plan, then an alternative plan must be submitted. If the DM does approve the plan (FIG. 5 step 5), then that plan is entered into the Approved Project Plan (FIG. 6 step d), according to the relevant Project Segment.

Each Project Segment is awarded a unique ID code. In one embodiment, the unique ID is a descriptive ID that is created by the system or manually. In some embodiments, the ID is built according to the category under which the plans fall (building shell, electric, plumbing, etc.), the general location described by the plans (e.g. basement, first floor, second floor etc.), or some other distinctive marker. Optionally the code may include the version of the plans. In a non-limiting example, the first version of the Project Segment including the electrical plans for the basement has a unique ID/code such as ‘elec00.1’. The first four letters designates the category (‘elec’ for electrical), the next two numbers designate the building level (‘00’ for the basement). This is the unique ID. The code may further include version number. In the example, the number after the point ‘.’ refers to the revision or version (‘.1’ is the 1^{st} version). The unique ID is ‘elec00’ and the version no is 1. The version number may or may not be included in the unique ID code.

In some embodiments, the Project Segments are further tagged or otherwise categorized according to intended task implementation. For example, Project Segment that has the schematics for the wiring system is tagged ‘ELEC’. In some embodiments, each Project Segment has a Project Placement Coordinate Set (PPCS) identifying the placement of the Project Segment within the Overview Project Plan or Architectural Drawings.

In a second stage of the process, the Implementation Stage, the Approved Project Plan is made available to practitioners who are tasked with implementing the plans (step 6). The professionals may be selected via tender or through direct selection, as with the Consultants (FIG. 6 step e). The management system provides multiple selection methods, some of which have be discussed above. Once selected, clearance is granted to the practitioners (FIG. 6 step f), who are referred to herein as Implementers. The Implementers are alerted, in step 7 (FIG. 5), to changes in plans or to new plans that have been added. Implementers only have access to Project Segments of the Approved Project Plan which includes only the most up-to-date plans. On the other hand, the Owner, the DM, possibly the IM and possibly also the Consultants may have access to previous versions of the plans. Access to previous versions of the plans that are stored on the system storage device may be granted for administrative or management related reasons.

During the Implementation stage, a sub-process called the Modification Process, can take place. The Owner, Consultants or the DM may make or suggest modifications (FIG. 5 step 8) to the plans (FIG. 6 step g). The DM may make modifications to the Overview plan, i.e. Architectural Drawings (FIG. 6 step h), which requires certain consultants to make modifications to the detailed plans (FIG. 6 step j) which are affected by the Architectural modifications. In this scenario, alerts (FIG. 5 step 9) (FIG. 6 step i) are sent to the Consultants requiring them to update or otherwise modify the detailed plans (step 10) they originally drew up in the Design Stage. The modifications are then subject to approval of the DM (FIG. 5 step 5) (FIG. 6 step k) before they become part of the Approved Project Plan (i.e. before the changes appear in the Project Segments available to the other Consultants and the Implementers).

Alternatively or additionally, Consultants may initiate/suggest modifications to certain detailed plans, modifications which may or may not affect other detailed plans and/or even the Architectural plans. All modifications are contingent upon the approval of the DM. The system alerts the DM to any modification which a Consultant (or the Owner) wishes to make. If the DM approves the modification then alerts are sent to Consultants (FIG. 5 step 9) in charge of Detailed Plans that are or may be affected by the suggested modification(s). The Consultants must update or otherwise modify the detailed plans (FIG. 5 step 10) they originally drew up in the Design Stage (Le. the detailed plan for which they are responsible). The modifications are then subject to approval of the DM (FIG. 5 step 5) before they become part of the Approved Project Plan (i.e. before the changes appear in the Project Segments available to the other Consultants and the Implementers).

When the modifications are approved (FIG. 6 step m), the Approved Project Plan is updated with the new modification(s). Each modified Project Segment gets a new code (unique ID with the version number updated) and the old set of plans is stored on the storage device. Implementers clearances are all updated to the latest plans (and they can no longer view the earlier plans). Consultants are granted clearance to the new plans and may retain clearance to the older versions of the plan, according to administrative decision. Alerts are then sent to the various Implementers (FIG. 6 step n) who will now have slightly new plans which they must implement.

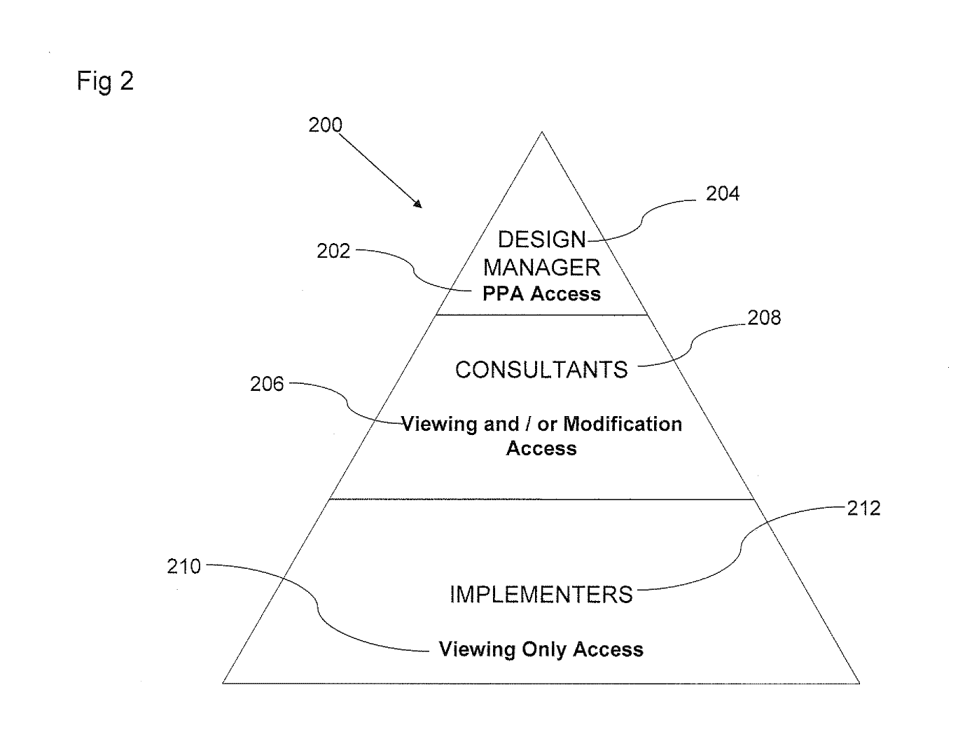

To further clarify the aforementioned two-stage process, the different types of access need to be explained. FIG. 2 depicts a clearance access hierarchy pyramid 200 of an embodiment of the current innovation including the type of access afforded at each level. Generally speaking, three types of access are granted in the management system. The first type of access is Project Plan Approval (PPA) access 202. PPA access is granted to the entity 204 in overall control of the project, which is usually is the Design Manager (additionally or in some special cases, alternatively, PPA access may be held by the Initiator). In our building project example above, Design Manager 204 is an Architect. In general, the Project Plan may only be approved by the Design Manager, who stands at the top of the project management hierarchy/pyramid. In the Design Stage (see FIG. 4) DM 204 must approve the detailed plans. In the Implementation Stage (again FIG. 4) Dm 204 approves modifications to the detailed plans.

The second type of access is Modification and Viewing access 206, also referred to simply as modification access. Users of the system who are categorized as Consultants 208 may be granted modification access. Modification access is a bit of a misnomer as the access granted to Consultants only allows them to suggest modifications to the project segments for which they are responsible. In the Design stage, Consultants draw up detailed plans which must be approved by DM 204. In the Implementation stage, Consultants suggest modifications to the detailed plans, and these modifications must be approved by DM 204. The system GUI (Graphical User Interface) allows Consultants to make modifications to the Project segments. In an exemplary embodiment, these modifications appear as ‘suggested changes’ (similar to the “tracked changes” feature in Microsoft Word®). The Design Manager (e.g. Architect) is alerted to the suggested modification (more about alerts below) and can either ‘accept’ or ‘reject’ the changes. Once accepted, the modifications become part of the Approved Project Plan which is available to all users according to clearance. Potentially, a Consultant may be granted modification access to certain project segments while being granted ‘viewing-only access’ (discussed immediately hereafter) to other project segments.

The third type of access is viewing-only or view-only access 210. This access is granted to users who have permission to see the particular project segments but may not modify them. Continuing the previous example, Electrician 212 is not a Consultant but rather an Implementer 212 of the project plan. The electrician is granted view-only access to Project Segments tagged ‘ELEC’ which show the electrician the electric plans that he must implement in the project. On the other hand, Electrical Engineer 208 is a Consultant 208 who is granted permission to view as well as modify the ‘ELEC’ project segments. Even though the main modifications to the Project Plan are made in the Design stage, during the Implementation stage, modifications and changes can be continually made (which is usually what happens in practice).

In general, modifications made to individual project segments, or to a group of project segments may affect other segments of the project plan. In some embodiments, access to the affected segments may not necessarily be granted to the Consultant user that made the original modification in the first place. This is a further reason why a Design Manager user (e.g. an Architect) must approve modifications before they are entered into the approved project plan. The system may alert the Project Manager to the fact the modifications suggested by Consultant users affect or may potentially affect other segments of the plan. The system software may include algorithms providing the system with logic rules learned by humans, often through experience. The system logic aids the system in decision or suggestion making, particularly with reference to which entities must or may be alerted when certain modifications are made. Thereby, the system may alert other Consultant users, who have responsibility/modification access over affected segments, to the modifications that have been made and affect or may affect segments of the project plan under their responsibility.

The group of Consultant users may include but is not limited to: Land Planners, Architects, Engineers, Designers, Landscape Architects and Designers, Lighting designers, Green and Sustainability experts, Construction Managers, General Contractors, Sub Contractors, Specialty contractors, Property Managers. The group of Implementers may include, but is not limited to, General Contractor, Soils Engineers, Graders, Framers, Plumbers, Electricians, Masons, Builders, Roofers, Tilers, and other professional tradesman and contractors that may be hired to implement the Project Plan, generally referred to as building site practitioners.

Implementation modules are sub-projects or mini-projects which include tasks that need to be implemented in the project plan which include, but are not limited to, project analysis, infrastructure, systems schematics, site preparation and grading, foundation and underground, building structure, shell and core, mechanical, plumbing and electrical, weatherproof and insulation, interior finishes, exterior finishes and site finishes.

Besides for Implementers, other individuals or groups that may be granted viewing-only access to the approved Project Plan may include officiating agencies, local planning & building departments, and planning commissions.

Alerts

An integral part of the Project Management System is the ability to alert relevant parties to modifications and changes that need to be taken into consideration and implemented. When any type of modification is made, the system sends (either manually, semi-automatically or fully automatically) an alert or alerts to project team members affected by the modification. For example, if a Consultant modifies (i.e. suggests a modification) to a project segment, the DM is alerted via electronic message, such as a SMS text message, e-mail, information notification viewable through the GUI of the system or the like. The DM then logs onto the system to review the changes and approve or disapprove them. If approved, electronic messages will be sent (again, whether self-triggered based on predetermined criteria or triggered by the DM) to all the Consultants and Implementers who have clearance to the project segments that are affected (whether directly or indirectly, as the system may make logical determinations as to which project segments are indirectly affected). The system may suggest a list of affected segments/consultants/implementers to alert. The GUI preferably suggests these alerts in a clear and efficient manner that is easy to implement, such as but not limited to checkboxes next to the names of the consultants to alert etc. Furthermore, the Owner may also be alerted to any or all of the modifications which are requested and/or approved. The alert may contain a varying degree of details regarding the changes. In a non-limiting example, an SMS alert may only include a very limited message referring the practitioner to a project (using the project unique ID) and the PPCS or unique ID of the affected or modified Project Segment. On the other hand, an email is also sent to the same practitioner including additional details of actual modification and perhaps a list of other Project Segments or systems that were affected by the modification. Furthermore, when the practitioner logs onto the system, say via the website, a message may appear or flash on the screen alerting the practitioner that modifications have been made and what the modifications are. In some instances, the practitioner may be expected to perform some action or task as a result of the modification. The alert may direct the practitioner to the required action and may even request confirmation that the task has been completed.

Access to System

As mentioned previously, access to the system is granted according to clearance. Each member of the Project is issued a username and password for logging on to the system. The logon may be via the system website, a downloaded client application residing in the user's computer, a mobile application for a mobile device such as a smartphone or iPad® and the like. The list of usernames and passwords resides in database 104 and is awarded a clearance via the system. Various methods for awarding the clearance are envisioned, including but not limited to the existence of a user profile having record fields where one or more record fields include the abovementioned tags and/or categories relevant to the particular user. A user that has a particular tag in a clearance record field is allowed access to Project Segments which are categorized with the same tags. A further record field may include the type of access afforded by the clearance. For example, an electrician may be awarded view-only access to all project segments tagged with the name ‘ELEC’.

Potentially, one professional may work on more than one project that is being managed by the system. The professional is awarded a single username and password combination which allows access to the system for all the projects in which the professional/user is involved. Potentially a list of the concurrent projects is presented to the user from which to choose. This list may additionally include a notification or indication of the status of the project and whether any action is currently required by the user. Once chosen, access is granted according to clearance as explained above.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A computer program product for managing projects comprising:
a. a computer useable medium having computer readable instructions embodied therein for managing an Approved Project Plan wherein said computer readable instructions, when executed on a computer, cause said computer to:
i. receive an Overview plan from a Design Manager;
ii. receive at least one Detailed Plan relating to at least a portion of said Overview plan, wherein said at least one Detailed plan is subject to approval by said Design Manager before said at least one detailed plan is included in the Approved Project Plan;
iii. grant view-and-modify access to at least a portion of the Approved Project Plan to a user having a modification clearance, wherein said view-and-modify access allows said user to suggest a modification to the Approved Project Plan; and
iv. grant view-only access to at least a portion of the Approved Project Plan to a user having a view-only clearance, wherein said view-only access allows said user with said view-only clearance to only view the Approved Project Plan and disallows said user from suggesting a modification to the Approved Project Plan.

2. The computer program product of claim 1, wherein said computer readable instructions, when executed on a computer, further cause said computer to:
v. alert said Design Manager regarding a suggested modification to at least one Detailed plan of the Approved Project Plan;
vi. modify said at least one Detailed plan of the Approved Project Plan according to said suggested modification if said suggested modification is approved by said Design Manager; and
vii. alert users with view-only and modification clearance for said modified Detailed plan of the Approved Project Plan, regarding said modification.

3. The computer program product of claim 2, wherein said alerting is accomplished by a method selected from the group including: automatically alerting, semi-automatically alerting and manually alerting.

4. The computer program product of claim 2, wherein said alerting said users includes sending a data-stream to said users in a form selected from the group including: a Short Text Service (SMS) message, an electronic mail (e-mail) message and an information message viewable via a Graphical User Interface (GUI) of the computer program product.

5. The computer program product of claim 1, wherein said project management package further comprises:
b. a Database (DB) including a Directory of Professionals (DOP), wherein said DOP includes information regarding Project Professionals; and
c. a Request for Proposal (RFP) module, for sending an RFP to at least one said Project Professional, selected from said DOP.

6. The computer program product of claim 5, wherein said project management package further comprises:
d. a Rating module, for rating said Project Professionals, said rating being stored in said DB.

7. The computer program product of claim 1, wherein said granting of said view-and-modify access and said view-only access is effected by said Design Manager.

8. The computer program product of claim 1, wherein the Approved Project Plan is accessible, according to said clearance, online over a data network.

9. The computer program product of claim 1, wherein said Overview Plan includes Architectural Drawings.
